(19) United States
(12) Patent Application Publication
(10) Pub. No.: US 2025/0180742 A1
(43) Pub. Date: Jun. 5, 2025

(54) SYSTEMS AND METHODS FOR COMBINING POLARIZATION INFORMATION WITH TIME-OF-FLIGHT INFORMATION

(71) Applicant: Meta Platforms Technologies, LLC, Menlo Park, CA (US)

(72) Inventors: Mantas Zurauskas, Redmond, WA (US); Yatong An, Redmond, WA (US); Youmin Wang, Bellevue, WA (US)

(21) Appl. No.: 18/951,242

(22) Filed: Nov. 18, 2024

Related U.S. Application Data
(60) Provisional application No. 63/604,330, filed on Nov. 30, 2023.

(51) Int. Cl. G01S 17/86; G01J 4/04; G01S 7/481; G01S 7/4865; G02B 27/00; G02B 27/01

(52) U.S. Cl. CPC G01S 17/86; G01J 4/04; G01S 7/4817; G01S 7/4865; G02B 27/0093; G02B 27/0172

(57) ABSTRACT

The disclosed method may include measuring, by a controller, a distance to an object based on a combination of polarization information of detected light and time-of-flight information of the detected light, wherein the detected light results from at least one of scattering or reflection of a light beam from an object. The disclosed method may additionally include performing, by an artificial reality system that includes the controller, one or more user interaction procedures based on information that includes the measured distance to the object. Various other methods, systems, and computer-readable media are also disclosed.

### CROSS REFERENCE TO RELATED APPLICATION

This application claims the benefit of U.S. Provisional Application No. 63/604,330, filed Nov. 30, 2023, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for combining polarization information of detected light with time-of-flight information of the detected light.

FIG. 2 is a graphical illustration relating zenith angle and degree of polarization of detected light.

FIG. 3 is a block diagram illustrating an example eye tracking system having a detector that includes photodetectors having polarizers that exhibit different orientations.

FIG. 4 is a block diagram illustrating an example eye tracking system that includes photodetectors having different meta-surfaces that deflecting different polarization states to different ones of the photodetectors.

FIG. 5 is a block diagram illustrating an example eye tracking system that includes a detector that is configured to detect light from a laser light source having a polarization rotator.

FIG. 6 is an illustration of an example artificial-reality system according to some embodiments of this disclosure.

FIG. 7 is an illustration of an example artificial-reality system with a handheld device according to some embodiments of this disclosure.

FIG. 8A is an illustration of example user interactions within an artificial-reality system according to some embodiments of this disclosure.

FIG. 8B is an illustration of example user interactions within an artificial-reality system according to some embodiments of this disclosure.

FIG. 9A is an illustration of example user interactions within an artificial-reality system according to some embodiments of this disclosure.

FIG. 9B is an illustration of example user interactions within an artificial-reality system according to some embodiments of this disclosure.

FIG. 10 is an illustration of an example augmented-reality system according to some embodiments of this disclosure.

FIG. 11A is an illustration of an example virtual-reality system according to some embodiments of this disclosure.

FIG. 11B is an illustration of another perspective of the virtual-reality systems shown in FIG. 11A.

FIG. 12 is a block diagram showing system components of example artificial-and virtual-reality systems.

FIG. 13 is an illustration of an example system that incorporates an eye-tracking subsystem capable of tracking a user's eye(s).

FIG. 14 is a more detailed illustration of various aspects of the eye-tracking subsystem illustrated in FIG. 13.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Current eye tracking systems can be categorized into two main categories: scanning based and camera based. Camera based system cannot reach high speed image rate (e.g., >500 frames per second (fps)) easily with relatively low cost. Moreover, camera systems rely on illumination of multiple LEDs, which adds to the total system's power consumption. On the other hand, scanning based eye tracking shows great promise thanks to its fast scanning speed, dynamic laser intensity control, and smaller (size, weight, and power) profile. However, current laser scanning based systems only collects specular and diffuse scattering light intensity information from the eye, using which still cannot guarantee high tracking accuracy and precision. Additional information is needed to be extracted from the laser scanning imaging so as to enhance the overall scanning imaging performance.

The present disclosure is generally directed to systems and methods for combining polarization information of detected light with time-of-flight information of the detected light. As will be explained in greater detail below, embodiments of the present disclosure may include a controller that measures a distance (e.g., eye depth) to an object (e.g., an eye) based on a combination of polarization information of detected light and time-of-flight information of the detected light, wherein the detected light results from at least one of scattering or reflection of a light beam (e.g., a scanning laser beam) from the object. In this way, an artificial reality system that includes the controller may employ the measured distance as eye tracking information and perform one or more user interaction procedures based on this information. In some of these embodiments, the controller may additionally measure, based on the polarization information, at least one of position or size of one or more regions (e.g., cornea, edge of pupil) of the object (e.g., pupil position, pupil size) from which the light beam is at least one of scattered or reflected. This additional eye tracking information may thus be obtained without adding a camera to obtain these measurements.

The disclosed systems and methods may achieve numerous benefits. For example, the time-of-flight information may provide a single depth measurement and the polarization information may provide multiple depth measurements that are more precise than the single depth measurement provided by the time-of-flight information. The controller may use the less precise, but single measurement provided by the time-of-flight information to determine which of the multiple, more precise measurements obtained from the polarization information is the correct measurement. Accordingly, the disclosed systems and methods may achieve a more precise measurement of distance (e.g., eye depth) and additional types of eye tracking information without needing to use a camera. Thus, the disclosed systems and methods may achieve a lower cost solution for obtaining high precision measurements while benefiting from a smaller (e.g., size, weight, power, etc.) profile.

Features from any of the embodiments described herein may be used in combination with one another in accordance with the general principles described herein. These and other embodiments, features, and advantages will be more fully understood upon reading the following detailed description in conjunction with the accompanying drawings and claims.

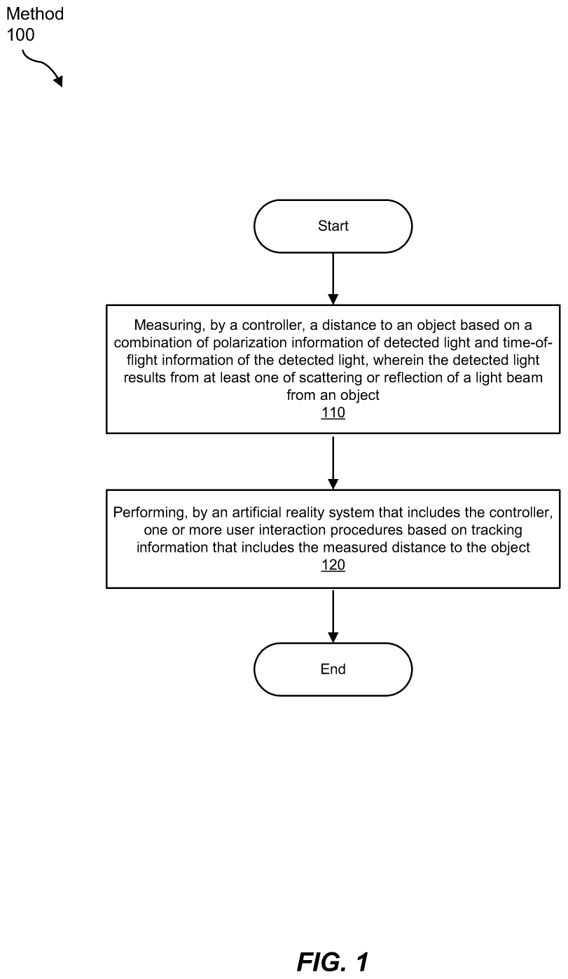

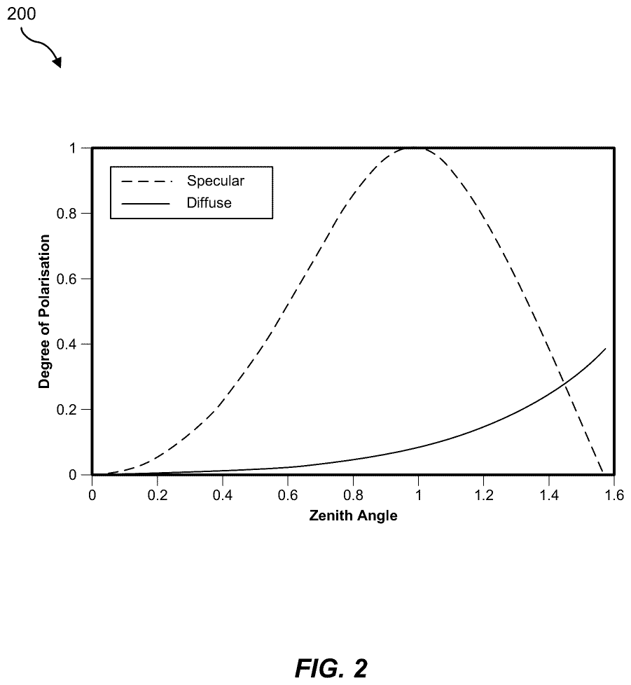

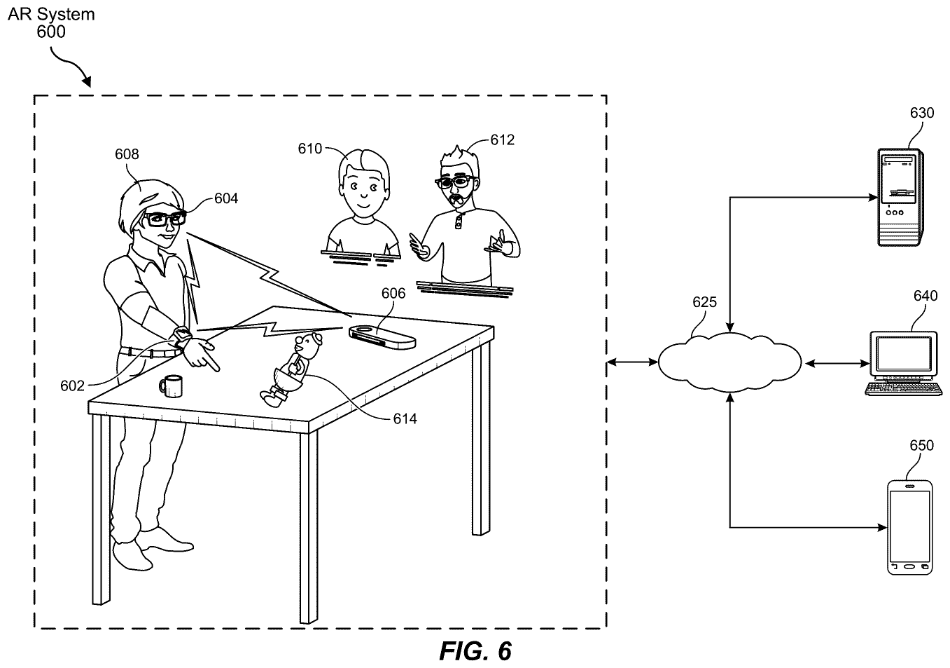

The following will provide, with reference to FIG. 1, detailed descriptions of example methods for combining polarization information of detected light with time-of-flight information of the detected light. Detailed descriptions of example systems for combining polarization information of detected light with time-of-flight information of the detected light will be provided with reference to FIGS. 2-5. Detailed descriptions of example artificial reality systems that may employ the combined information will be provided with reference to FIGS. 6-14.

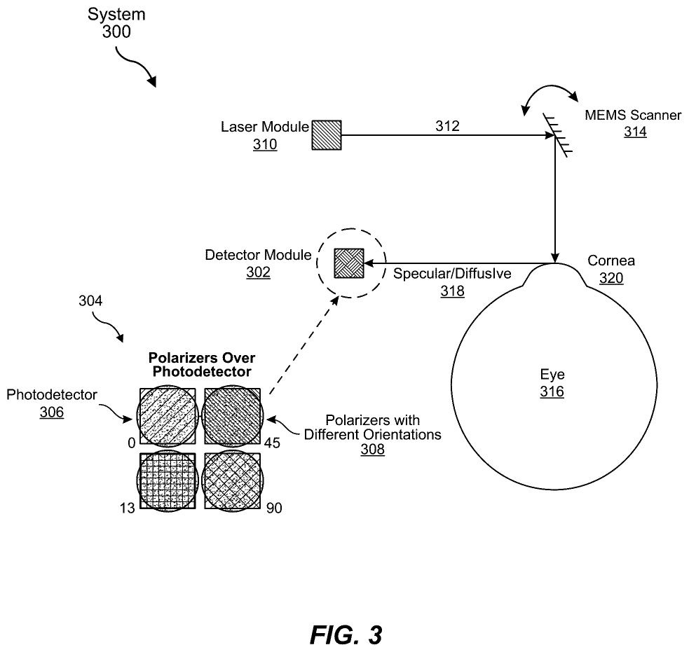

FIG. 1 is a flow diagram of an exemplary computer-implemented method 100 for combining polarization information of detected light with time-of-flight information of the detected light. The steps shown in FIG. 1 may be performed by any suitable computer-executable code and/or computing system, including the system(s) illustrated in FIGS. 3-5 and 10-14. In one example, each of the steps shown in FIG. 1 may represent an algorithm whose structure includes and/or is represented by multiple sub-steps, examples of which will be provided in greater detail below.

As illustrated in FIG. 1 at step 110 one or more of the systems described herein may measure a distance to an object. For example, a controller may measure a distance to an object based on a combination of polarization information of detected light and time-of-flight information of the detected light, wherein the detected light results from at least one of scattering or reflection of a light beam from an object.

In some embodiments, the term “controller” may refer to electronic components that manage and coordinate the operation of other components within an electronic device (e.g., controlling inputs, processing data, and/or generating outputs). Examples of controllers include, without limitation: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

In some embodiments, the term “polarization information” may refer to information regarding geometrical orientation of oscillations of one or more transverse waves. Examples of polarization information include, without limitation, azimuth and zenith angle. In the context of polarization, “azimuth angle” refers to the horizontal direction of a surface normal relative to a reference point (usually north), while “zenith angle” indicates the angle between the surface normal and the line of sight, essentially describing how “tilted” a surface appears from the observer's perspective. Both angles may be extracted from the polarization characteristics of reflected light, allowing for 3D surface reconstruction based on polarization imaging techniques.

In some embodiments, the term “time-of-flight information” may refer to information regarding a time taken for a wave or signal to travel from a source to an object and back. Examples of time-of-flight information include, without limitation, information useful for calculating distance, speed, or other properties of an object or medium.

In some embodiments, the term “scattering” may refer to a physical phenomenon that occurs when light interacts with particles or irregularities in a medium, causing the light to deviate from its original path. Examples of scattering include, without limitation, the way light behaves when it interacts with a medium that contains particles or the boundary between different mediums where defects or structures are present.

In some embodiments, the term “reflection” may refer to behavior of light when light rays bounce off a surface and change direction. Examples of reflection include, without limitation, specular reflection, diffuse reflection, and total internal reflection.

In some embodiments, the term “light beam” may refer to a group of light rays given out from a source, where a light ray includes light travelling in one direction in a straight line. Examples of light beams include, without limitation, parallel, convergent, divergent, combined, high beam, moving head beam, and accent lighting. In this context, example light sources may include, without limitation, laser light sources, parabolic reflectors, etc.

The systems described herein may perform step 110 in a variety of ways. In one example, the controller may further measure at step 110, based on the polarization information, position and/or size of one or more regions of the object from which the light beam is at least one of scattered or reflected. Additionally, a detector may, at step 110, detect light resulting from at least one of scattering or reflection of a light beam from an object. The controller may, at step 110, received sensed information (e.g., light intensity, wavelength, polarization, etc.) form the detector. The detector may, at step 110, detect intensities of the detected light for a plurality of polarizations of the detected light. In some implementations, the detector may include a first photodetector having a first polarizer exhibiting a first orientation and a second photodetector having a second polarizer exhibiting a second orientation that is different from the first orientation. Additionally or alternatively, the detector may include a first photodetector having a first meta-surface deflecting a first polarization state to the first photodetector and a second photodetector having a second meta-surface deflecting a second polarization state to the second photodetector that is different from the first polarization state. Additionally or alternatively, the detector may detect light from a laser light source having a polarization rotator. In some implementations, the polarization information may include azimuth and zenith angle of a point and/or the time-of-flight information may include a time taken for the light beam to at least one of scatter or reflect from the object and return to the detector. In some implementations, the controller may, at step 110, combine the polarization information and the time-of-flight information by using the time-of-flight information to resolve data ambiguities in reflected angle data included in the polarization information.

At step 120 one or more of the systems described herein may perform one or more user interaction procedures. For example, an artificial reality system that includes the controller may perform one or more user interaction procedures based on tracking information that includes the measured distance to the object.

In some embodiments, the term “artificial reality system” may refer to a system capable of providing an artificial reality experience for a user. Examples of artificial reality systems include, without limitation, systems detailed herein with reference to FIGS. 6-14.

In some embodiments, the term “user interaction procedures” may refer to procedures that modify or adjust presentation or an artificial reality in response to user actions and/or that record information about user engagement with content presented in the artificial reality environment. Examples of user interaction procedures include, without limitation, procedures that respond to or record user gestures, user eye movements, user gaze direction, user gaze pattern, user point of gaze, user pupil dilation, user blinking, user facial expressions, and/or user interactions with real or virtual objects or environments.

In some embodiments, the term “tracking information” may refer to information produced by a system capable of tracking an object. Examples of tracking information include, without limitation, eye tracking information, user gestures, user facial expressions, and/or user interactions with real or virtual objects or environments. In this context, eye tracking information may include user eye movements, user gaze direction, user gaze pattern, user point of gaze, user pupil dilation, user blinking, etc.

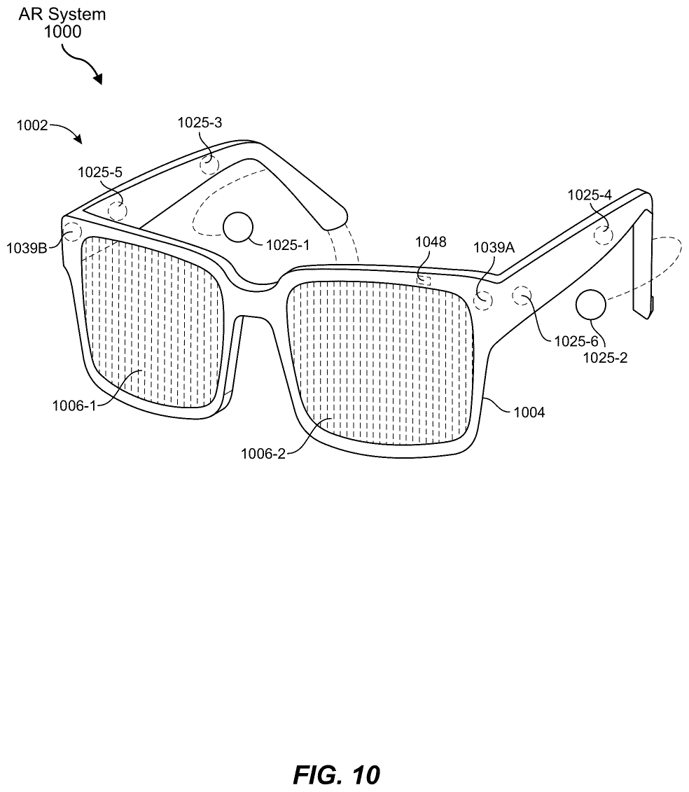

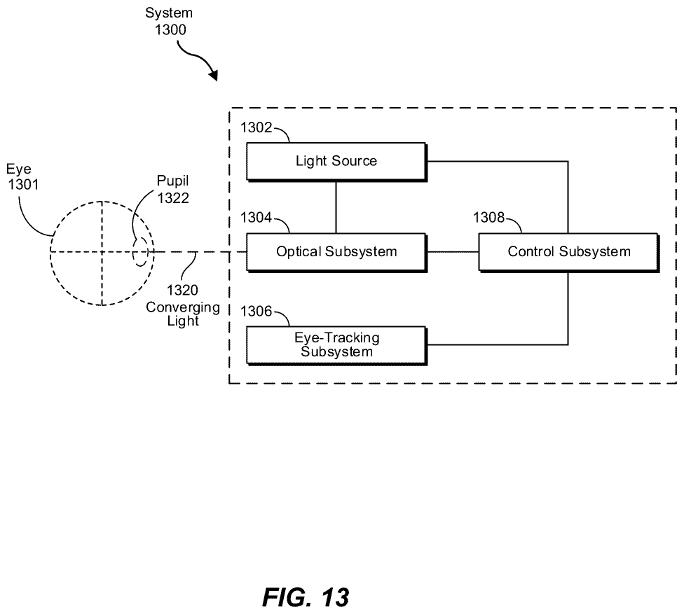

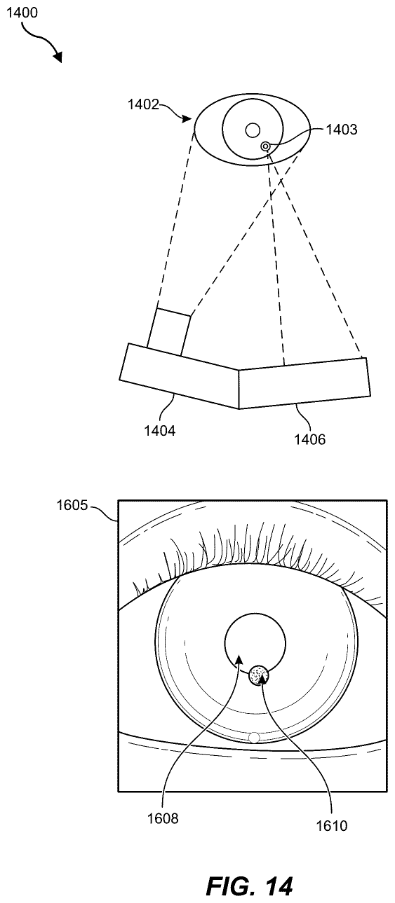

The systems described herein may perform step 120 in a variety of ways. In one example, the tracking information may further include the position and/or size of the one or more regions. In some implementations, the artificial reality system may correspond to any of the artificial reality systems described herein, such as those described with reference to FIGS. 10-12. In some of these implementations, the artificial reality system may include an eye tracking system, controller may include any of the eye tracking systems described herein, such as those described with reference to FIGS. 13 and 14. In some implementations, the eye tracking system may include any of the detectors and/or controllers described herein, such as those described with reference to FIGS. 3-5. Moreover, example user-interaction procedures that may be performed by the artificial reality system may correspond to any of the user interactions described herein, such as those described with reference to FIGS. 6-9a.

FIGS. 2-5 detail systems relating to eye tracking and other distance measurement and imaging applications. In some examples, a device may provide eye tracking and/or eye imaging using a combination of polarization-sensitive laser scanning data and time-of-flight (TOF) data. In some examples, a device may include a light source, an optical scanner, and a detector. The light source, such as a laser, may direct a light beam towards the optical scanner, such as a MEMS (micro-electromechanical systems) based optical scanner. The optical scanner may be configured to scan the light beam over the surface of an object, for example, a body part such as an eye. Scattered light may be detected by a detector, for example, a detector including one or more photodetectors such as a quad photodetector. In this context, the term “scattered light” may include specular or diffuse reflected light and/or backscattered light. The term scattered light may include light returned to the detector due to the incidence of the light beam on the object. Detected light may include at least part of the scattered light.

In some examples, each photodetector may be sensitive to a different light polarization, for example, using polarizers or metamaterial surfaces associated with one or more photodetectors. In some examples, each photodetector has an associated polarizer that passes a particular polarization of scattered light to the detector. Polarizers may include linear polarizers and/or circular polarizers.

In some examples, different regions of the eye may be identified and/or differentiated using the polarization properties of the detected light. Example eye regions may include cornea, sclera, pupil, iris, conjunctiva, or other regions within or proximate the eye. In some examples, regions proximate the eye may be detected and/or differentiated from eye regions or other proximate eye regions. Regions proximate the eye may include the eyelid or proximate skin regions. In some examples, scattered light from an exterior surface may be detected. In some examples, scattered light from an interior structure of the eye may be detected, such as light scattered by the lens, retina, and/or fovea.

Time-of-flight (TOF) measurements (e.g., using laser light pulses) may allow improved determination of distances to (and the shape of) the eye, particularly when combined with polarization-sensitive laser scanning measurements. In some examples, distance measurement precision may be improved using a combination of polarized light detection and TOF-based distance data. For example, reflected angle data may be determined using reflected light intensity and/or polarization and any data ambiguities may be removed using the TOF data. As used herein, scattered light may include backscattered and/or reflected light, and may include specular and/or diffuse reflection of light, and may refer to detected light resulting from incidence of the light beam on an object such as an eye.

In some examples, a single laser and photodetector may be used and the detected polarization may vary with time using at least one adjustable (e.g., rotatable) polarization component in the incidence and/or reflected light path. In some examples, the polarization of the light beam may be adjusted at intervals and corresponding detected light intensity measured. Applications include improved eye tracking, eye shape determination and pupil imaging.

In some examples, the device may include a wearable device and the object may be a portion of the body of a user such as a hand, wrist, arm, leg, foot, head, or portion thereof. In some examples, the device may include head-mounted device and the object may be the head of a user or a portion thereof, such as one or more eyes and optionally an eye region of the face (e.g., including an eye and surrounding regions such as the eyelid or surrounding skin).

Applications may include eye tracking. In some examples, the location of other body parts such as the fingers may be tracked. In some examples, approaches described herein may allow eye tracking, gaze direction determination, and determination of other user data.

Camera based eye trackers may not provide a sufficiently high-speed image rate, and may be limited to measurements made at less than 500 frames per second (fps) without significant additional expense. Camera systems typically use eye illumination with multiple LEDs, which adds to the system power consumption.

Scanning based eye tracking allows a relatively fast scanning speed, dynamic laser intensity control, reduced size, reduced weight, and reduced power (e.g., relative to camera-based systems). Laser scanning based systems may collect scattered light (e.g., including reflected and/or diffuse scattered light) and determine the detected light intensity for different regions of the eye. In some examples, detected light intensity may be determined for a plurality of polarization states of the scattered light, providing improved information relating to the eye as discussed in more detail below. Improved eye tracking performance may be obtained by obtaining additional polarization-based data from the laser scanning data. In some examples, tracking accuracy and distance precision may be less than camera-based systems. However, a polarization-based scanning laser system may allow improved distinction between different regions of the eye. By combining polarization-based scanning data with time-of-flight (TOF) data, improved distance precision may be obtained relative to the use of polarization based scanning data alone and certain data ambiguities may be resolved.

In some examples, polarization-sensitive scanning may include detecting scattered intensities for a plurality of polarizations of the light incident on the eye and/or scattered light from the eye. Polarizations may include linear polarizations of different orientations, circular polarizations of different handedness (e.g., right hand or left hand), or any suitable combination of polarization states.

Light returned from the eye may provide data such as intensity, wavelength, polarization, scattering angle, or other information. Imaging using intensity data provide the spatial variation of reflectivity of the eye. Polarization data may provide biomaterial information and may be used differentiate different regions of the eye, and also for eye characterization. Returned light may include scattered and/or reflected light, and may also be referred to as scattered or backscattered light.

For example, the cornea scatters light having different polarization characteristics compared with light scattered from the edge of the pupil or from other regions of the eye. Features such as the polarization degree and scattering angle may provide information differentiating various regions of the eye, and allow determination of eye tracking data such as the pupil position, pupil size, gaze direction, and the like. Polarization measurements may be used to identify and segment out Purkinje reflections. For example, reflections (and/or associated images based on the reflections) may be detected based on the reflection of light (e.g., polarized light) from the cornea outer surface, the cornea inner surface, the lens outer surface, and/or the lens inner surface. In some examples, reflections may be detected and used to determine gaze direction, eye focus, eye focus time, visual refractive errors (e.g., long sightedness, short sightedness, astigmatism, and the like), location of the blind spot, and the like.

Polarization information may be obtained using a camera-based system or a scanning laser system. However, camera-based systems may have problems such as poor time resolution of detected changes.

In some examples, polarization imaging of the eye may be obtained using a scanning laser system. The laser beam may be steered in different direction (e.g., over an angular range) using an optical scanner. Backscattered light may be detected by a detector, for example, in effectively real time using one or more photodetectors sensitive to different light polarizations. As described in more detail below, in some examples, a detector may include a plurality of photodetectors and each photodetector of the plurality of photodetectors may provide detected intensity data for different polarizations of the respective detected light. In some examples, the polarization of a light beam incident on the eye may have a time-varying polarization and a single detector may provide a similarly time-varying detected intensity that may allow a relationship between scattered light intensity and polarization to be determined.

In some examples, a device may include a laser scanning system having polarization sensitivity. The polarization sensitivity (e.g., detection of scattered light intensity for one or more polarizations of the scattered light) allows improved differentiation of different regions of the eye, such as differentiation between one or more of the cornea, sclera, pupil, iris, eyelid or other region within or proximate the eye. In some examples, polarization sensitivity may allow improved depth measurement, and may allow improved determination of the eye shape based on a plurality of depth measurements.

Polarization measurements may be used to obtain the azimuth and zenith angle of a point within a region of the eye. However, there may be ambiguities in depth data obtained using polarization measurements alone.

FIG. 2 shows a possible relationship 200 between zenith angle and degree of polarization, for example, as determined using an approach described by Smith et al., “Linear depth estimation from an uncalibrated, monocular polarisation image,” Computer Vision-ECCV 2016: 14th European Conference, Proceedings, Part VIII 14, 15 pages, Springer (2016). As shown, the azimuth and zenith angle may have multiple values for a single measurement point.

Azimuth and zenith information may be combined with distance data (e.g., determined from time-of-flight measurements) to resolve any ambiguity. Also, the accuracy of the depth determination may be improved by combining two types of data (e.g., depth from polarization measurements and depth from laser scanning). Thus, more accurate 3D shape measurement and position may be achieved.

Time-of-flight data may include determination of depth information based on the time delay between a signal emitted from a device and a resulting scattered signal being detected (e.g., a scattered signal reflected and/or scattered from an object surface). The time delay is due to the time taken to travel twice the distance to the object surface. The scattered signal may be detected by a suitable detector within the device, such as a photodetector for optical signals. The signal may be an optical signal (e.g., a visible or IR signal), a millimeter wave signal, a radar signal or other electromagnetic signal, an ultrasound signal, or other suitable signal. In some examples, TOF data may be obtained by measuring a delay between emitted and detected pulses. In some examples, TOF data may be obtained from a determined phase relationship between emitted and detected signals. In some examples, TOF data may be obtained using interference, mixing, or other interaction between emitted and detected signals.

FIG. 3 shows an example system 300 that may be used for eye tracking. The system includes a laser scanning polarization imager including and a detector system 302 including a plurality of photodetectors 304 (e.g., a quad photodetector). Each photodetector 306 of the plurality of photodetectors 304 may include a polarizer 308 (e.g., a linear polarizers) having a particular polarization direction. FIG. 3 shows a quad photodetector with linear polarization directions oriented at zero, 45, 90 and 135 degrees for the respective photodetectors 306, where zero is a reference direction that may be arbitrary.

The light source 310 may include a laser, such as a semiconductor laser, such as a laser diode. In some examples, the light source 310 may include a vertical cavity surface emitting laser (VCSEL). The light beam 312 may include laser radiation. In some examples, the light source 310 may be configured to emit a visible or IR (e.g., near-IR) light beam when energized. A reflector 314, such as a MEMS scanner, may direct the light beam 312 onto an object 316, such as an eye. Light 318 (e.g., specular and/or diffusive) may be reflected and/or scattered from the object 316 and detected by the detector system 302. A controller may measure a distance to the object 316 based on this detected light 318 as detailed above with reference to FIG. 1. Additionally, the controller may, as detailed above with reference to FIG. 1, measure position and/or size of one or more regions 320 of the object, such as a pupil and/or cornea.

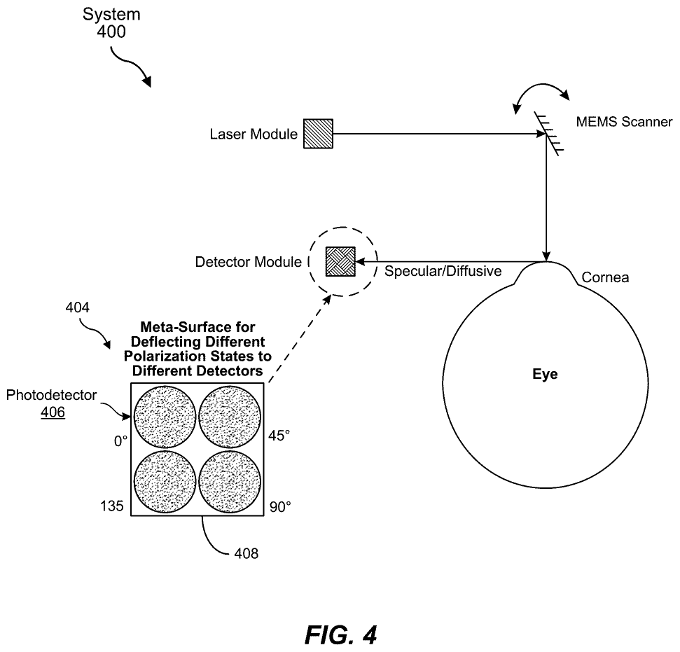

FIG. 4 shows a further example system 400 including laser scanning polarization imaging with quad photodetectors and having certain features that may be the same as those detailed with reference to FIG. 3. In some examples, a detector 402 including a plurality of photodetectors 404 (such as a quad photodetector) may include a metamaterial layer 408 (sometimes termed a metamaterial surface or metasurface) configured to direct different polarization states to respective photodetectors 406.

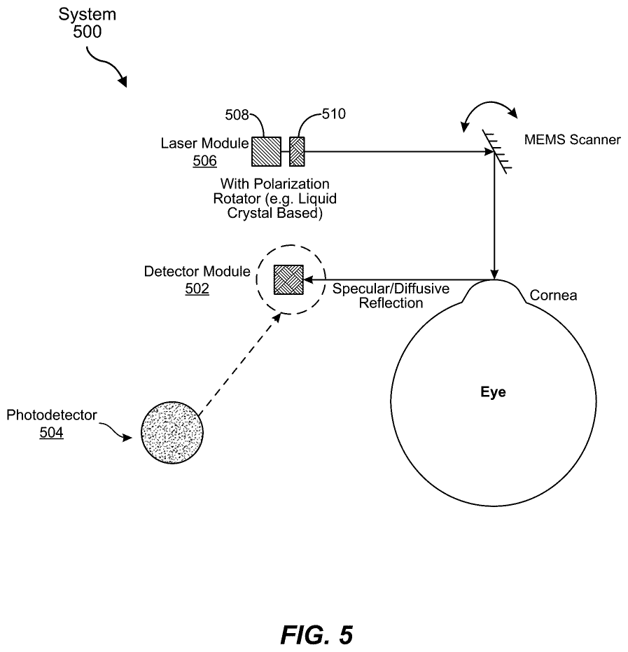

FIG. 5 shows a further example system 500 including a detector system 502 that includes a single photodetector 504 with time-dependent adjustment of the light polarization. For example, a laser module 506 may include a laser 508 (e.g., a solid state laser such as a laser diode) and a polarization rotator 510 (e.g., a liquid crystal based polarization rotator). Intensity measurements may be made for a plurality of polarization states by determining the detected light intensity for two or more incident polarization states. The polarization state of the incident light may be adjusted at intervals, for example, to zero, 45, 90 and 135 degrees. The system may operate in an analogous manner to that described above in relation to FIG. 3, but does not require particular polarizer orientations due to the adjustment of the incident polarization. In some examples, polarizers may be included, for example, to reduce the effects of stray light or for any other suitable reason. In some examples, the light polarization may be stepped (e.g., through 45 degrees or any other angular step), adjusted continuously, or adjusted quasi-continuously (e.g., the plane of polarization may be adjusted in angular steps having a magnitude less than 45 degrees).

Examples include methods and apparatus for eye tracking and/or imaging using laser scanning. A device may include a light source (e.g., a laser), an optical scanner, and a detector. In some examples, a laser directs a laser beam towards an optical scanner (e.g., a MEMS-based optical scanner) configured to scan the light beam (e.g., a laser beam) over the eye surface. Scattered and/or reflected light may be detected by an array of photodetectors (e.g., a quad photodetector), where each photodetector is sensitive to a different light polarization (e.g., using polarizers or metamaterial surfaces). Different parts of the eye may be identified using the polarization properties of the detected light. Time-of-flight (TOF) measurements (e.g., using laser light pulses) allow determination of distances to (and the shape of) the eye. Distance precision may be improved using a combination of polarized light detection and TOF-based distance data. For example, reflected angle data may be determined using reflected light polarization and ambiguities removed using the TOF data. As used herein, scattered light may include backscattered and/or reflected light, and may include specular and/or diffuse reflection of light. In some examples, a single laser and photodetector may be used and the detected polarization may vary with time using at least one adjustable (e.g., rotatable) polarization component in the incidence and/or reflected light path. Applications include improved eye tracking, eye shape determination and pupil imaging.

### Example Embodiments

Example 1: A device may include a detector configured detect light resulting from at least one of scattering or reflection of a light beam from an object and a controller configured to measure polarization information of the detected light, measure time-of-flight information of the detected light, and measure a distance to the object based on a combination of the polarization information and the time-of-flight information.
Example 2: The device of Example 1, wherein the controller is further configured to measure, based on the polarization information, at least one of position or size of one or more regions of the object from which the light beam is at least one of scattered or reflected.
Example 3: The device of any of Examples 1 and 2, wherein the detector is configured to detected intensities of the detected light for a plurality of polarizations of the detected light.
Example 4: The device of any of Examples 1 to 3, wherein the detector includes a first photodetector having a first polarizer exhibiting a first orientation and a second photodetector having a second polarizer exhibiting a second orientation that is different from the first orientation.
Example 5: The device of any of Examples 1 to 4, wherein the detector includes a first photodetector having a first meta-surface deflecting a first polarization state to the first photodetector and a second photodetector having a second meta-surface deflecting a second polarization state to the second photodetector that is different from the first polarization state.
Example 6: The device of any of Examples 1 to 5, wherein the detector is configured to detect light from a laser light source having a polarization rotator.
Example 7: The device of any of Examples 1 to 6, wherein the object is an eye and the controller is configured to include the measured distance in eye tracking information.
Example 8: The device of any of Examples 1 to 7, wherein the time-of-flight information includes a time taken for the light beam to at least one of scatter or reflect from the object and return to the detector.
Example 9: The device of any of Examples 1 to 8, wherein the controller is configured to combine the polarization information and the time-of-flight information by using the time-of-flight information to resolve data ambiguities in reflected angle data included in the polarization information.
Example 10: An eye tracking system may include a laser light source configured to emit a laser light beam, an optical scanner configured to scan the laser light beam over an angular range, a detector configured detect light resulting from at least one of scattering or reflection of the laser light beam from an eye, and a controller configured to measure polarization information of the detected light, measure time-of-flight information of the detected light, and measure a distance to the eye based on a combination of the polarization information and the time-of-flight information.
Example 11: The eye tracking system of Example 10, wherein the controller is further configured to measure, based on the polarization information, at least one of position or size of one or more regions of the eye from which the laser light beam is at least one of scattered or reflected.
Example 12: The eye tracking system of any of Examples 10 and 11, wherein the detector is configured to detected intensities of the detected light for a plurality of polarizations of the detected light.
Example 13: The eye tracking system of any of Examples 10 to 12, wherein the detector includes a first photodetector having a first polarizer exhibiting a first orientation and a second photodetector having a second polarizer exhibiting a second orientation that is different from the first orientation.
Example 14: The eye tracking system of any of Examples 10 to 13, wherein the detector includes a first photodetector having a first meta-surface deflecting a first polarization state to the first photodetector and a second photodetector having a second meta-surface deflecting a second polarization state to the second photodetector that is different from the first polarization state.
Example 15: The eye tracking system of any of Examples 10 to 14, wherein the detector is configured to detect light from a laser light source having a polarization rotator.
Example 16: The eye tracking system of any of Examples 10 to 13, wherein the controller is configured to include the measured distance in eye tracking information.
Example 17: The eye tracking system of any of Examples 10 to 16, wherein the time-of-flight information includes a time taken for the laser light beam to at least one of scatter or reflect from the eye and return to the detector.
Example 18: The eye tracking system of any of Examples 10 to 17, wherein the controller is configured to combine the polarization information and the time-of-flight information by using the time-of-flight information to resolve data ambiguities in reflected angle data included in the polarization information.
Example 19: A method may include measuring, by a controller, a distance to an object based on a combination of polarization information of detected light and time-of-flight information of the detected light, wherein the detected light results from at least one of scattering or reflection of a light beam from an object, and performing, by an artificial reality system that includes the controller, one or more user interaction procedures based on tracking information that includes the measured distance to the object.
Example 20: The method of Example 19, further including measuring, by the controller and based on the polarization information, at least one of position or size of one or more regions of the object from which the light beam is at least one of scattered or reflected, wherein the tracking information further includes the at least one of position or size of the one or more regions.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented reality environments, markerless augmented-reality environments, location-based augmented-reality environments, and projection-based augmented-reality environments), hybrid-reality environments, and/or any other type or form of mixed-or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

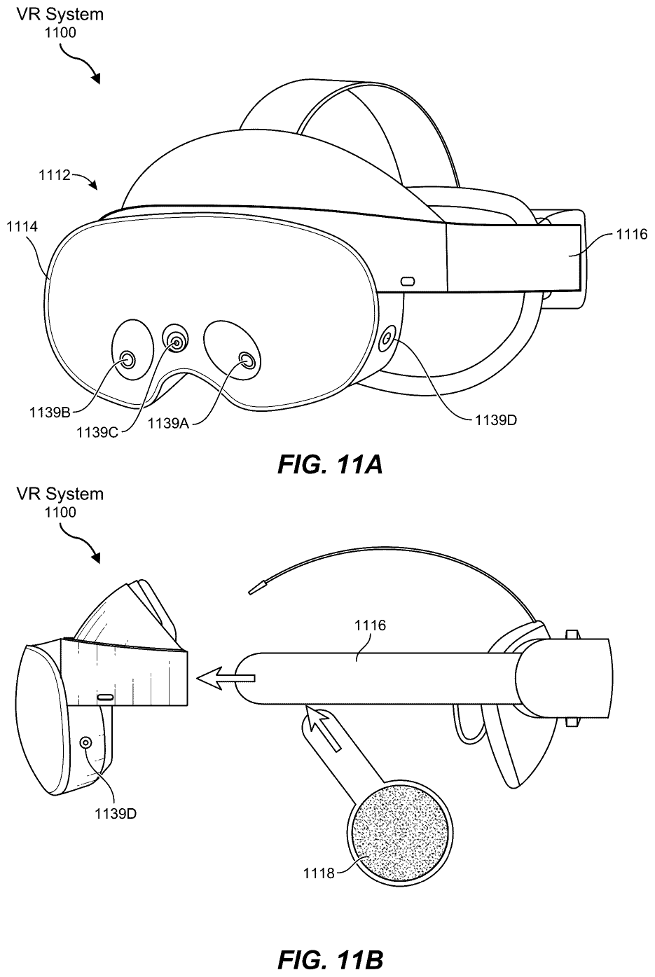

AR systems may be implemented in a variety of different form factors and configurations. Some AR systems may be designed to work without near-eye displays (NEDs). Other AR systems may include a NED that also provides visibility into the real world (such as, e.g., augmented-reality system 1000 in FIG. 10) or that visually immerses a user in an artificial reality (such as, e.g., virtual-reality system 1100 in FIGS. 11A and 11B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

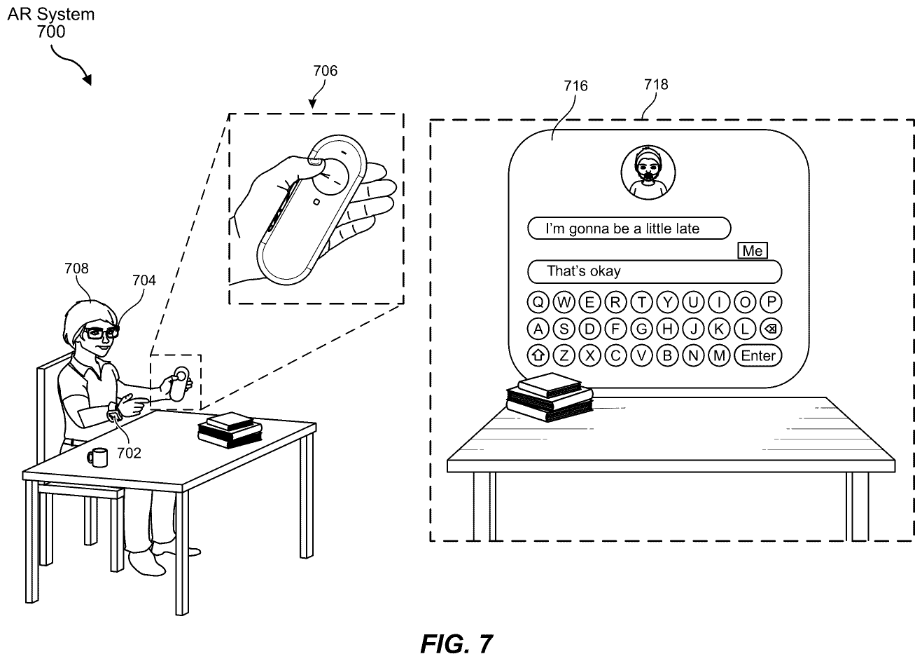

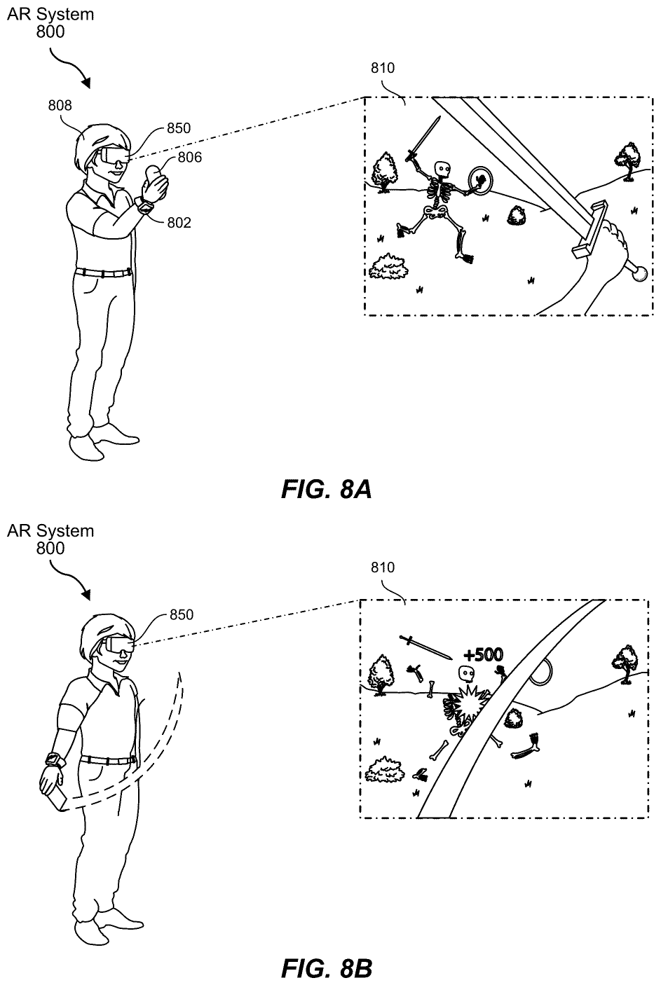

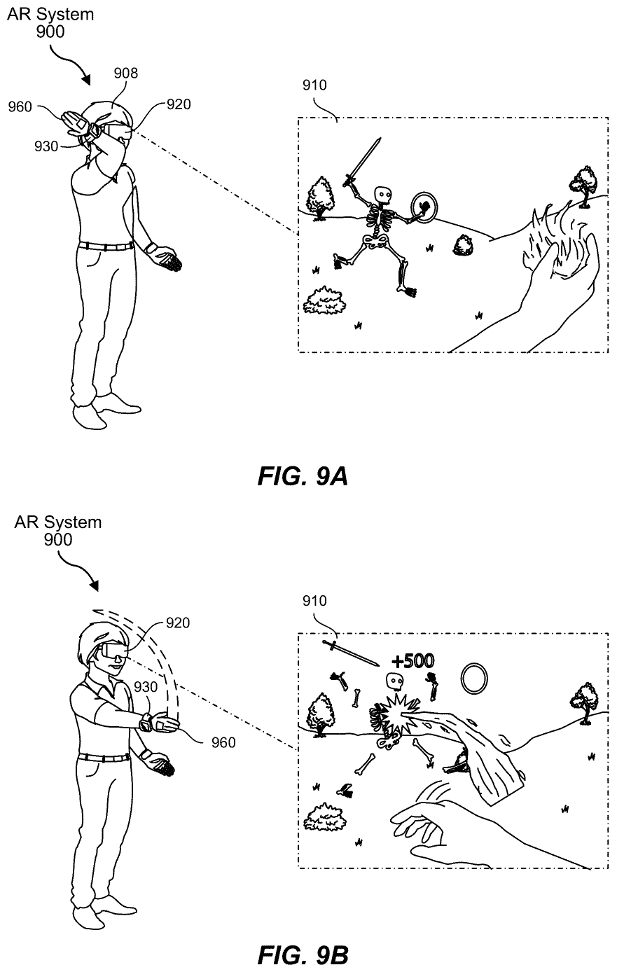

FIGS. 6-9B illustrate example artificial-reality (AR) systems in accordance with some embodiments. FIG. 6 shows a first AR system 600 and first example user interactions using a wrist-wearable device 602, a head-wearable device (e.g., AR glasses 1000), and/or a handheld intermediary processing device (HIPD) 606. FIG. 7 shows a second AR system 700 and second example user interactions using a wrist-wearable device 702, AR glasses 704, and/or an HIPD 706. FIGS. 8A and 8B show a third AR system 800 and third example user 808 interactions using a wrist-wearable device 802, a head-wearable device (e.g., VR headset 850), and/or an HIPD 806. FIGS. 9A and 9B show a fourth AR system 900 and fourth example user 908 interactions using a wrist-wearable device 930, VR headset 920, and/or a haptic device 960 (e.g., wearable gloves).

Referring to FIG. 6, wrist-wearable device 602, AR glasses 604, and/or HIPD 606 can communicatively couple via a network 625 (e.g., cellular, near field, Wi-Fi, personal area network, wireless LAN, etc.). Additionally, wrist-wearable device 602, AR glasses 604, and/or HIPD 606 can also communicatively couple with one or more servers 630, computers 640 (e.g., laptops, computers, etc.), mobile devices 650 (e.g., smartphones, tablets, etc.), and/or other electronic devices via network 625 (e.g., cellular, near field, Wi-Fi, personal area network, wireless LAN, etc.).

In FIG. 6, a user 608 is shown wearing wrist-wearable device 602 and AR glasses 604 and having HIPD 606 on their desk. The wrist-wearable device 602, AR glasses 604, and HIPD 606 facilitate user interaction with an AR environment. In particular, as shown by first AR system 600, wrist-wearable device 602, AR glasses 604, and/or HIPD 606 cause presentation of one or more avatars 610, digital representations of contacts 612, and virtual objects 614. As discussed below, user 608 can interact with one or more avatars 610, digital representations of contacts 612, and virtual objects 614 via wrist-wearable device 602, AR glasses 604, and/or HIPD 606.

User 608 can use any of wrist-wearable device 602, AR glasses 604, and/or HIPD 606 to provide user inputs. For example, user 608 can perform one or more hand gestures that are detected by wrist-wearable device 602 (e.g., using one or more EMG sensors and/or IMUs) and/or AR glasses 604 (e.g., using one or more image sensor or camera, described below in reference to FIGS. 10-12) to provide a user input. Alternatively, or additionally, user 608 can provide a user input via one or more touch surfaces of wrist-wearable device 602, AR glasses 604, HIPD 606, and/or voice commands captured by a microphone of wrist-wearable device 602, AR glasses 604, and/or HIPD 606. In some embodiments, wrist-wearable device 602, AR glasses 604, and/or HIPD 606 include a digital assistant to help user 608 in providing a user input (e.g., completing a sequence of operations, suggesting different operations or commands, providing reminders, confirming a command, etc.). In some embodiments, user 608 can provide a user input via one or more facial gestures and/or facial expressions. For example, cameras of wrist-wearable device 602, AR glasses 604, and/or HIPD 606 can track eyes of user 608 for navigating a user interface.

Wrist-wearable device 602, AR glasses 604, and/or HIPD 606 can operate alone or in conjunction to allow user 608 to interact with the AR environment. In some embodiments, HIPD 606 is configured to operate as a central hub or control center for the wrist-wearable device 602, AR glasses 604, and/or another communicatively coupled device. For example, user 608 can provide an input to interact with the AR environment at any of wrist-wearable device 602, AR glasses 604, and/or HIPD 606, and HIPD 606 can identify one or more back-end and front-end tasks to cause the performance of the requested interaction and distribute instructions to cause the performance of the one or more back-end and front-end tasks at wrist-wearable device 602, AR glasses 604, and/or HIPD 606. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). HIPD 606 can perform the back-end tasks and provide wrist-wearable device 602 and/or AR glasses 604 operational data corresponding to the performed back-end tasks such that wrist-wearable device 602 and/or AR glasses 604 can perform the front-end tasks. In this way, HIPD 606, which has more computational resources and greater thermal headroom than wrist-wearable device 602 and/or AR glasses 604, performs computationally intensive tasks and reduces the computer resource utilization and/or power usage of wrist-wearable device 602 and/or AR glasses 604.

In the example shown by first AR system 600, HIPD 606 identifies one or more back-end tasks and front-end tasks associated with a user request to initiate an AR video call with one or more other users (represented by avatar 610 and the digital representation of contact 612) and distributes instructions to cause the performance of the one or more back-end tasks and front-end tasks. In particular, HIPD 606 performs back-end tasks for processing and/or rendering image data (and other data) associated with the AR video call and provides operational data associated with the performed back-end tasks to AR glasses 604 such that the AR glasses 604 perform front-end tasks for presenting the AR video call (e.g., presenting avatar 610 and digital representation of contact 612).

In some embodiments, HIPD 606 can operate as a focal or anchor point for causing the presentation of information. This allows user 608 to be generally aware of where information is presented. For example, as shown in first AR system 600, avatar 610 and the digital representation of contact 612 are presented above HIPD 606. In particular, HIPD 606 and AR glasses 604 operate in conjunction to determine a location for presenting avatar 610 and the digital representation of contact 612. In some embodiments, information can be presented a predetermined distance from HIPD 606 (e.g., within 5 meters). For example, as shown in first AR system 600, virtual object 614 is presented on the desk some distance from HIPD 606. Similar to the above example, HIPD 606 and AR glasses 604 can operate in conjunction to determine a location for presenting virtual object 614. Alternatively, in some embodiments, presentation of information is not bound by HIPD 606. More specifically, avatar 610, digital representation of contact 612, and virtual object 614 do not have to be presented within a predetermined distance of HIPD 606.

User inputs provided at wrist-wearable device 602, AR glasses 604, and/or HIPD 606 are coordinated such that the user can use any device to initiate, continue, and/or complete an operation. For example, user 608 can provide a user input to AR glasses 604 to cause AR glasses 604 to present virtual object 614 and, while virtual object 614 is presented by AR glasses 604, user 608 can provide one or more hand gestures via wrist-wearable device 602 to interact and/or manipulate virtual object 614.

FIG. 7 shows a user 708 wearing a wrist-wearable device 702 and AR glasses 704, and holding an HIPD 706. In second AR system 700, the wrist-wearable device 702, AR glasses 704, and/or HIPD 706 are used to receive and/or provide one or more messages to a contact of user 708. In particular, wrist-wearable device 702, AR glasses 704, and/or HIPD 706 detect and coordinate one or more user inputs to initiate a messaging application and prepare a response to a received message via the messaging application.

In some embodiments, user 708 initiates, via a user input, an application on wrist-wearable device 702, AR glasses 704, and/or HIPD 706 that causes the application to initiate on at least one device. For example, in second AR system 700, user 708 performs a hand gesture associated with a command for initiating a messaging application (represented by messaging user interface 716), wrist-wearable device 702 detects the hand gesture and, based on a determination that user 708 is wearing AR glasses 704, causes AR glasses 704 to present a messaging user interface 716 of the messaging application. AR glasses 704 can present messaging user interface 716 to user 708 via its display (e.g., as shown by a field of view 718 of user 708). In some embodiments, the application is initiated and executed on the device (e.g., wrist-wearable device 702, AR glasses 704, and/or HIPD 706) that detects the user input to initiate the application, and the device provides another device operational data to cause the presentation of the messaging application. For example, wrist-wearable device 702 can detect the user input to initiate a messaging application, initiate and run the messaging application, and provide operational data to AR glasses 704 and/or HIPD 706 to cause presentation of the messaging application. Alternatively, the application can be initiated and executed at a device other than the device that detected the user input. For example, wrist-wearable device 702 can detect the hand gesture associated with initiating the messaging application and cause HIPD 706 to run the messaging application and coordinate the presentation of the messaging application.

Further, user 708 can provide a user input provided at wrist-wearable device 702, AR glasses 704, and/or HIPD 706 to continue and/or complete an operation initiated at another device. For example, after initiating the messaging application via wrist-wearable device 702 and while AR glasses 704 present messaging user interface 716, user 708 can provide an input at HIPD 706 to prepare a response (e.g., shown by the swipe gesture performed on HIPD 706). Gestures performed by user 708 on HIPD 706 can be provided and/or displayed on another device. For example, a swipe gestured performed on HIPD 706 is displayed on a virtual keyboard of messaging user interface 716 displayed by AR glasses 704.

In some embodiments, wrist-wearable device 702, AR glasses 704, HIPD 706, and/or any other communicatively coupled device can present one or more notifications to user 708. The notification can be an indication of a new message, an incoming call, an application update, a status update, etc. User 708 can select the notification via wrist-wearable device 702, AR glasses 704, and/or HIPD 706 and can cause presentation of an application or operation associated with the notification on at least one device. For example, user 708 can receive a notification that a message was received at wrist-wearable device 702, AR glasses 704, HIPD 706, and/or any other communicatively coupled device and can then provide a user input at wrist-wearable device 702, AR glasses 704, and/or HIPD 706 to review the notification, and the device detecting the user input can cause an application associated with the notification to be initiated and/or presented at wrist-wearable device 702, AR glasses 704, and/or HIPD 706.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 704 can present to user 708 game application data, and HIPD 706 can be used as a controller to provide inputs to the game. Similarly, user 708 can use wrist-wearable device 702 to initiate a camera of AR glasses 704, and user 308 can use wrist-wearable device 702, AR glasses 704, and/or HIPD 706 to manipulate the image capture (e.g., zoom in or out, apply filters, etc.) and capture image data.

Users may interact with the devices disclosed herein in a variety of ways. For example, as shown in FIGS. 8A and 8B, a user 808 may interact with an AR system 800 by donning a VR headset 850 while holding HIPD 806 and wearing wrist-wearable device 802. In this example, AR system 800 may enable a user to interact with a game 810 by swiping their arm. One or more of VR headset 850, HIPD 806, and wrist-wearable device 802 may detect this gesture and, in response, may display a sword strike in game 810. Similarly, in FIGS. 9A and 9B, a user 908 may interact with an AR system 900 by donning a VR headset 920 while wearing haptic device 960 and wrist-wearable device 930. In this example, AR system 900 may enable a user to interact with a game 910 by swiping their arm. One or more of VR headset 920, haptic device 960, and wrist-wearable device 930 may detect this gesture and, in response, may display a spell being cast in game 810.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

[symbol]

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiogramar EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configured to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 1002.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

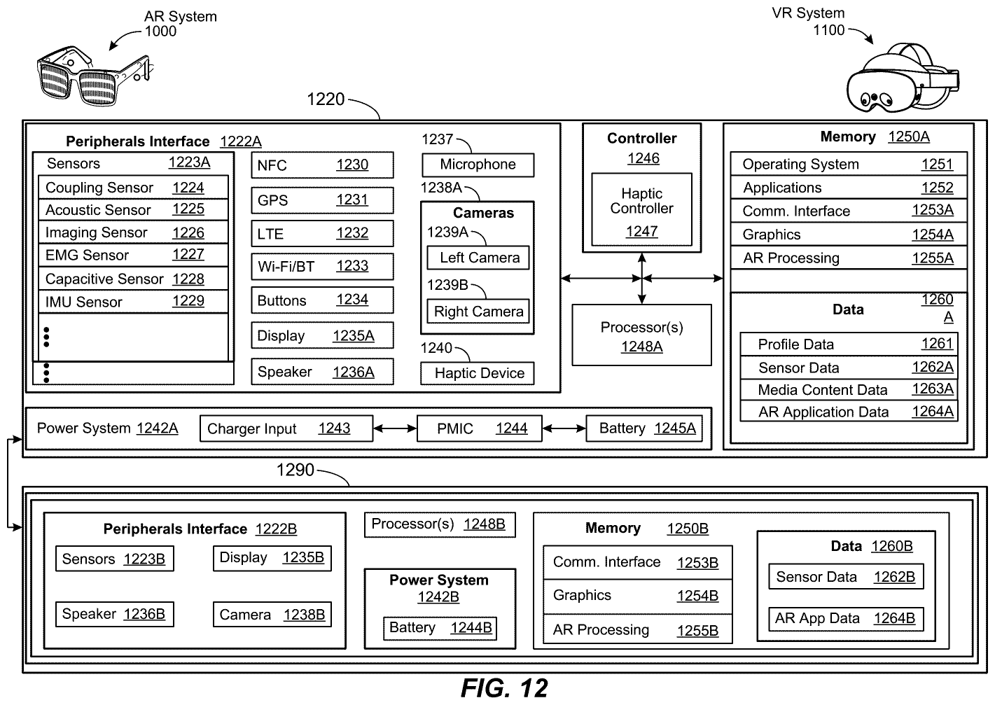

FIGS. 10 to 12 show example artificial-reality systems, which can be used as or in connection with a wrist-wearable device. In some embodiments, AR system 1000 includes an eyewear device 1002, as shown in FIG. 10. In some embodiments, VR system 1110 includes a head-mounted display (HMD) 1112, as shown in FIGS. 11A and 11B. In some embodiments, AR system 1000 and VR system 1110 can include one or more analogous components (e.g., components for presenting interactive artificial-reality environments, such as processors, memory, and/or presentation devices, including one or more displays and/or one or more waveguides), some of which are described in more detail with respect to FIG. 12. As described herein, a head-wearable device can include components of eyewear device 1002 and/or head-mounted display 1112. Some embodiments of head-wearable devices do not include any displays, including any of the displays described with respect to AR system 1000 and/or VR system 1110. While the example artificial-reality systems are respectively described herein as AR system 1000 and VR system 1110, either or both of the example AR systems described herein can be configured to present fully-immersive virtual-reality scenes presented in substantially all of a user's field of view or subtler augmented-reality scenes that are presented within a portion, less than all, of the user's field of view.

FIG. 10 show an example visual depiction of AR system 1000, including an eyewear device 1002 (which may also be described herein as augmented-reality glasses, and/or smart glasses). AR system 1000 can include additional electronic components that are not shown in FIG. 10, such as a wearable accessory device and/or an intermediary processing device, in electronic communication or otherwise configured to be used in conjunction with the eyewear device 1002. In some embodiments, the wearable accessory device and/or the intermediary processing device may be configured to couple with eyewear device 1002 via a coupling mechanism in electronic communication with a coupling sensor 1224 (FIG. 12), where coupling sensor 1224 can detect when an electronic device becomes physically or electronically coupled with eyewear device 1002. In some embodiments, eyewear device 1002 can be configured to couple to a housing 1290 (FIG. 12), which may include one or more additional coupling mechanisms configured to couple with additional accessory devices. The components shown in FIG. 10 can be implemented in hardware, software, firmware, or a combination thereof, including one or more signal-processing components and/or application-specific integrated circuits (ASICs).

Eyewear device 1002 includes mechanical glasses components, including a frame 1004 configured to hold one or more lenses (e.g., one or both lenses 1006-1 and 1006-2). One of ordinary skill in the art will appreciate that eyewear device 1002 can include additional mechanical components, such as hinges configured to allow portions of frame 1004 of eyewear device 1002 to be folded and unfolded, a bridge configured to span the gap between lenses 1006-1 and 1006-2 and rest on the user's nose, nose pads configured to rest on the bridge of the nose and provide support for eyewear device 1002, earpieces configured to rest on the user's ears and provide additional support for eyewear device 1002, temple arms configured to extend from the hinges to the earpieces of eyewear device 1002, and the like. One of ordinary skill in the art will further appreciate that some examples of AR system 1000 can include none of the mechanical components described herein. For example, smart contact lenses configured to present artificial reality to users may not include any components of eyewear device 1002.

Eyewear device 1002 includes electronic components, many of which will be described in more detail below with respect to FIG. 12. Some example electronic components are illustrated in FIG. 10, including acoustic sensors 1025-1, 1025-2, 1025-3, 1025-4, 1025-5, and 1025-6, which can be distributed along a substantial portion of the frame 1004 of eyewear device 1002. Eyewear device 1002 also includes a left camera 1039A and a right camera 1039B, which are located on different sides of the frame 1004. Eyewear device 1002 also includes a processor 1048 (or any other suitable type or form of integrated circuit) that is embedded into a portion of the frame 1004.

FIGS. 11A and 11B show a VR system 1110 that includes a head-mounted display (HMD) 1112 (e.g., also referred to herein as an artificial-reality headset, a head-wearable device, a VR headset, etc.), in accordance with some embodiments. As noted, some artificial-reality systems (e.g., AR system 1000) may, instead of blending an artificial reality with actual reality, substantially replace one or more of a user's visual and/or other sensory perceptions of the real world with a virtual experience (e.g., AR systems 800 and 900).

HMD 1112 includes a front body 1114 and a frame 1116 (e.g., a strap or band) shaped to fit around a user's head. In some embodiments, front body 1114 and/or frame 1116 include one or more electronic elements for facilitating presentation of and/or interactions with an AR and/or VR system (e.g., displays, IMUs, tracking emitter or detectors). In some embodiments, HMD 1112 includes output audio transducers (e.g., an audio transducer 1118), as shown in FIG. 11B. In some embodiments, one or more components, such as the output audio transducer(s) 1118 and frame 1116, can be configured to attach and detach (e.g., are detachably attachable) to HMD 1112 (e.g., a portion or all of frame 1116, and/or audio transducer 1118), as shown in FIG. 11B. In some embodiments, coupling a detachable component to HMD 1112 causes the detachable component to come into electronic communication with HMD 1112.

FIGS. 11A and 11B also show that VR system 1110 includes one or more cameras, such as left camera 1139A and right camera 1139B, which can be analogous to left and right cameras 1039A and 1039B on frame 1004 of eyewear device 1002. In some embodiments, VR system 1110 includes one or more additional cameras (e.g., cameras 1139C and 1139D), which can be configured to augment image data obtained by left and right cameras 1139A and 1139B by providing more information. For example, camera 1139C can be used to supply color information that is not discerned by cameras 1139A and 1139B. In some embodiments, one or more of cameras 1139A to 1139D can include an optional IR cut filter configured to remove IR light from being received at the respective camera sensors.

FIG. 12 illustrates a computing system 1220 and an optional housing 1290, each of which show components that can be included in AR system 1000 and/or VR system 1110. In some embodiments, more or fewer components can be included in optional housing 1290 depending on practical restraints of the respective AR system being described.

In some embodiments, computing system 1220 can include one or more peripherals interfaces 1222A and/or optional housing 1290 can include one or more peripherals interfaces 1222B. Each of computing system 1220 and optional housing 1290 can also include one or more power systems 1242A and 1242B, one or more controllers 1246 (including one or more haptic controllers 1247), one or more processors 1248A and 1248B (as defined above, including any of the examples provided), and memory 1250A and 1250B, which can all be in electronic communication with each other. For example, the one or more processors 1248A and 1248B can be configured to execute instructions stored in memory 1250A and 1250B, which can cause a controller of one or more of controllers 1246 to cause operations to be performed at one or more peripheral devices connected to peripherals interface 1222A and/or 1222B. In some embodiments, each operation described can be powered by electrical power provided by power system 1242A and/or 1242B.

In some embodiments, peripherals interface 1222A can include one or more devices configured to be part of computing system 1220, some of which have been defined above and/or described with respect to wrist-wearable devices. For example, peripherals interface 1222A can include one or more sensors 1223A. Some example sensors 1223A include one or more coupling sensors 1224, one or more acoustic sensors 1225, one or more imaging sensors 1226, one or more EMG sensors 1227, one or more capacitive sensors 1228, one or more IMU sensors 1229, and/or any other types of sensors explained above or described with respect to any other embodiments discussed herein.

In some embodiments, peripherals interfaces 1222A and 1222B can include one or more additional peripheral devices, including one or more NFC devices 1230, one or more GPS devices 1231, one or more LTE devices 1232, one or more Wi-Fi and/or Bluetooth devices 1233, one or more buttons 1234 (e.g., including buttons that are slidable or otherwise adjustable), one or more displays 1235A and 1235B, one or more speakers 1236A and 1236B, one or more microphones 1237, one or more cameras 1238A and 1238B (e.g., including the left camera 1239A and/or a right camera 1239B), one or more haptic devices 1240, and/or any other types of peripheral devices defined above or described with respect to any other embodiments discussed herein.

AR systems can include a variety of types of visual feedback mechanisms (e.g., presentation devices). For example, display devices in AR system 1000 and/or VR system 1110 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 1235A and 1235B can be coupled to each of the lenses 1006-1 and 1006-2 of AR system 1000. Displays 1235A and 1235B may be coupled to each of lenses 1006-1 and 1006-2, which can act together or independently to present an image or series of images to a user. In some embodiments, AR system 1000 includes a single display 1235A or 1235B (e.g., a near-eye display) or more than two displays 1235A and 1235B. In some embodiments, a first set of one or more displays 1235A and 1235B can be used to present an augmented-reality environment, and a second set of one or more display devices 1235A and 1235B can be used to present a virtual-reality environment. In some embodiments, one or more waveguides are used in conjunction with presenting artificial-reality content to the user of AR system 1000 (e.g., as a means of delivering light from one or more displays 1235A and 1235B to the user's eyes). In some embodiments, one or more waveguides are fully or partially integrated into the eyewear device 1002. Additionally, or alternatively to display screens, some artificial-reality systems include one or more projection systems. For example, display devices in AR system 1000 and/or VR system 1110 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 1235A and 1235B.

Computing system 1220 and/or optional housing 1290 of AR system 1000 or VR system 1110 can include some or all of the components of a power system 1242A and 1242B. Power systems 1242A and 1242B can include one or more charger inputs 1243, one or more PMICs 1244, and/or one or more batteries 1245A and 1244B.

Memory 1250A and 1250B may include instructions and data, some or all of which may be stored as non-transitory computer-readable storage media within the memories 1250A and 1250B. For example, memory 1250A and 1250B can include one or more operating systems 1251, one or more applications 1252, one or more communication interface applications 1253A and 1253B, one or more graphics applications 1254A and 1254B, one or more AR processing applications 1255A and 1255B, and/or any other types of data defined above or described with respect to any other embodiments discussed herein.

Memory 1250A and 1250B also include data 1260A and 1260B, which can be used in conjunction with one or more of the applications discussed above. Data 1260A and 1260B can include profile data 1261, sensor data 1262A and 1262B, media content data 1263A, AR application data 1264A and 1264B, and/or any other types of data defined above or described with respect to any other embodiments discussed herein.

In some embodiments, controller 1246 of eyewear device 1002 may process information generated by sensors 1223A and/or 1223B on eyewear device 1002 and/or another electronic device within AR system 1000. For example, controller 1246 can process information from acoustic sensors 1025-1 and 1025-2. For each detected sound, controller 1246 can perform a direction of arrival (DOA) estimation to estimate a direction from which the detected sound arrived at eyewear device 1002 of AR system 1000. As one or more of acoustic sensors 1225 (e.g., the acoustic sensors 1025-1, 1025-2) detects sounds, controller 1246 can populate an audio data set with the information (e.g., represented in FIG. 12 as sensor data 1262A and 1262B).

In some embodiments, a physical electronic connector can convey information between eyewear device 1002 and another electronic device and/or between one or more processors 1048, 1248A, 1248B of AR system 1000 or VR system 1110 and controller 1246. The information can be in the form of optical data, electrical data, wireless data, or any other transmittable data form. Moving the processing of information generated by eyewear device 1002 to an intermediary processing device can reduce weight and heat in the eyewear device, making it more comfortable and safer for a user. In some embodiments, an optional wearable accessory device (e.g., an electronic neckband) is coupled to eyewear device 1002 via one or more connectors. The connectors can be wired or wireless connectors and can include electrical and/or non-electrical (e.g., structural) components. In some embodiments, eyewear device 1002 and the wearable accessory device can operate independently without any wired or wireless connection between them.

In some situations, pairing external devices, such as an intermediary processing device (e.g., HIPD 606, 706, 806) with eyewear device 1002 (e.g., as part of AR system 1000) enables eyewear device 1002 to achieve a similar form factor of a pair of glasses while still providing sufficient battery and computation power for expanded capabilities. Some, or all, of the battery power, computational resources, and/or additional features of AR system 1000 can be provided by a paired device or shared between a paired device and eyewear device 1002, thus reducing the weight, heat profile, and form factor of eyewear device 1002 overall while allowing eyewear device 1002 to retain its desired functionality. For example, the wearable accessory device can allow components that would otherwise be included on eyewear device 1002 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 1002 standing alone. Because weight carried in the wearable accessory device can be less invasive to a user than weight carried in the eyewear device 1002, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 1000 and/or VR system 1110 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 11A and 11B show VR system 1110 having cameras 1139A to 1139D, which can be used to provide depth information for creating a voxel field and a two-dimensional mesh to provide object information to the user to avoid collisions.

In some embodiments, AR system 1000 and/or VR system 1110 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 1000 and/or VR system 1110, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

FIG. 13 is an illustration of an example system 1300 that incorporates an eye-tracking subsystem capable of tracking a user's eye(s). As depicted in FIG. 13, system 1300 may include a light source 1302, an optical subsystem 1304, an eye-tracking subsystem 1306, and/or a control subsystem 1308. In some examples, light source 1302 may generate light for an image (e.g., to be presented to an eye 1301 of the viewer). Light source 1302 may represent any of a variety of suitable devices. For example, light source 1302 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 1304 may receive the light generated by light source 1302 and generate, based on the received light, converging light 1320 that includes the image. In some examples, optical subsystem 1304 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 1320. Further, various mechanical couplings may serve to maintain the relative spacing and/or the orientation of the optical components in any suitable combination.

In one embodiment, eye-tracking subsystem 1306 may generate tracking information indicating a gaze angle of an eye 1301 of the viewer. In this embodiment, control subsystem 1308 may control aspects of optical subsystem 1304 (e.g., the angle of incidence of converging light 1320) based at least in part on this tracking information. Additionally, in some examples, control subsystem 1308 may store and utilize historical tracking information (e.g., a history of the tracking information over a given duration, such as the previous second or fraction thereof) to anticipate the gaze angle of eye 1301 (e.g., an angle between the visual axis and the anatomical axis of eye 1301). In some embodiments, eye-tracking subsystem 1306 may detect radiation emanating from some portion of eye 1301 (e.g., the cornea, the iris, the pupil, or the like) to determine the current gaze angle of eye 1301. In other examples, eye-tracking subsystem 1306 may employ a wavefront sensor to track the current location of the pupil.

Any number of techniques can be used to track eye 1301. Some techniques may involve illuminating eye 1301 with infrared light and measuring reflections with at least one optical sensor that is tuned to be sensitive to the infrared light. Information about how the infrared light is reflected from eye 1301 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 1306 may be digitized (i.e., converted to an electronic signal). Further, the sensor may transmit a digital representation of this electronic signal to one or more processors (for example, processors associated with a device including eye-tracking subsystem 1306). Eye-tracking subsystem 1306 may include any of a variety of sensors in a variety of different configurations. For example, eye-tracking subsystem 1306 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 1306 to track the movement of eye 1301. In another example, these processors may track the movements of eye 1301 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 1306 may be programmed to use an output of the sensor(s) to track movement of eye 1301. In some embodiments, eye-tracking subsystem 1306 may analyze the digital representation generated by the sensors to extract eye rotation information from changes in reflections. In one embodiment, eye-tracking subsystem 1306 may use corneal reflections or glints (also known as Purkinje images) and/or the center of the eye's pupil 1322 as features to track over time.

In some embodiments, eye-tracking subsystem 1306 may use the center of the eye's pupil 1322 and infrared or near-infrared, non-collimated light to create corneal reflections. In these embodiments, eye-tracking subsystem 1306 may use the vector between the center of the eye's pupil 1322 and the corneal reflections to compute the gaze direction of eye 1301. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 1306 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 1301 may act as a retroreflector as the light reflects off the retina, thereby creating a bright pupil effect similar to a red-eye effect in photography. If the illumination source is offset from the optical path, then the eye's pupil 1322 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 1308 may control light source 1302 and/or optical subsystem 1304 to reduce optical aberrations (e.g., chromatic aberrations and/or monochromatic aberrations) of the image that may be caused by or influenced by eye 1301. In some examples, as mentioned above, control subsystem 1308 may use the tracking information from eye-tracking subsystem 1306 to perform such control. For example, in controlling light source 1302, control subsystem 1308 may alter the light generated by light source 1302 (e.g., by way of image rendering) to modify (e.g., pre-distort) the image so that the aberration of the image caused by eye 1301 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

FIG. 14 is a more detailed illustration of various aspects of the eye-tracking subsystem illustrated in FIG. 13. As shown in this figure, an eye-tracking subsystem 1400 may include at least one source 1404 and at least one sensor 1406. Source 1404 generally represents any type or form of element capable of emitting radiation. In one example, source 1404 may generate visible, infrared, and/or near-infrared radiation. In some examples, source 1404 may radiate non-collimated infrared and/or near-infrared portions of the electromagnetic spectrum towards an eye 1402 of a user. Source 1404 may utilize a variety of sampling rates and speeds. For example, the disclosed systems may use sources with higher sampling rates in order to capture fixational eye movements of a user's eye 1402 and/or to correctly measure saccade dynamics of the user's eye 1402. As noted above, any type or form of eye-tracking technique may be used to track the user's eye 1402, including optical-based eye-tracking techniques, ultrasound-based eye-tracking techniques, etc.

Sensor 1406 generally represents any type or form of element capable of detecting radiation, such as radiation reflected off the user's eye 1402. Examples of sensor 1406 include, without limitation, a charge coupled device (CCD), a photodiode array, a complementary metal-oxide-semiconductor (CMOS) based sensor device, and/or the like. In one example, sensor 1406 may represent a sensor having predetermined parameters, including, but not limited to, a dynamic resolution range, linearity, and/or other characteristic selected and/or designed specifically for eye tracking.

As detailed above, eye-tracking subsystem 1400 may generate one or more glints. As detailed above, a glint 1403 may represent reflections of radiation (e.g., infrared radiation from an infrared source, such as source 1404) from the structure of the user's eye. In various embodiments, glint 1403 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 14 shows an example image 1405 captured by an eye-tracking subsystem, such as eye-tracking subsystem 1400. In this example, image 1405 may include both the user's pupil 1408 and a glint 1410 near the same. In some examples, pupil 1408 and/or glint 1410 may be identified using an artificial-intelligence-based algorithm, such as a computer-vision-based algorithm. In one embodiment, image 1405 may represent a single frame in a series of frames that may be analyzed continuously in order to track the eye 1402 of the user. Further, pupil 1408 and/or glint 1410 may be tracked over a period of time to determine a user's gaze.

In one example, eye-tracking subsystem 1400 may be configured to identify and measure the inter-pupillary distance (IPD) of a user. In some embodiments, eye-tracking subsystem 1400 may measure and/or calculate the IPD of the user while the user is wearing the artificial reality system. In these embodiments, eye-tracking subsystem 1400 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 1300 and/or eye-tracking subsystem 1400 may be incorporated into any of the augmented-reality systems in and/or virtual-reality systems described herein in to enable these systems to perform various eye-tracking tasks (including one or more of the eye-tracking operations described herein).

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive detected light to be transformed, transform the detected light, output a result of the transformation to measure a distance, use the result of the transformation to interact with a user, and store the result of the transformation to provide tracking data. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a detector configured detect light resulting from at least one of scattering or reflection of a light beam from an object; and
a controller configured to measure polarization information of the detected light, measure time-of-flight information of the detected light, and measure a distance to the object based on a combination of the polarization information and the time-of-flight information.

2. The device of claim 1, wherein the controller is further configured to measure, based on the polarization information, at least one of position or size of one or more regions of the object from which the light beam is at least one of scattered or reflected.

3. The device of claim 1, wherein the detector is configured to detected intensities of the detected light for a plurality of polarizations of the detected light.

4. The device of claim 1, wherein the detector includes a first photodetector having a first polarizer exhibiting a first orientation and a second photodetector having a second polarizer exhibiting a second orientation that is different from the first orientation.

5. The device of claim 1, wherein the detector includes a first photodetector having a first meta-surface deflecting a first polarization state to the first photodetector and a second photodetector having a second meta-surface deflecting a second polarization state to the second photodetector that is different from the first polarization state.

6. The device of claim 1, wherein the detector is configured to detect light from a laser light source having a polarization rotator.

7. The device of claim 1, wherein the object is an eye and the controller is configured to include the measured distance in eye tracking information.

8. The device of claim 1, wherein the time-of-flight information includes a time taken for the light beam to at least one of scatter or reflect from the object and return to the detector.

9. The device of claim 1, wherein the controller is configured to combine the polarization information and the time-of-flight information by using the time-of-flight information to resolve data ambiguities in reflected angle data included in the polarization information.

10. An eye tracking system, comprising:
a laser light source configured to emit a laser light beam;
an optical scanner configured to scan the laser light beam over an angular range;
a detector configured detect light resulting from at least one of scattering or reflection of the laser light beam from an eye; and
a controller configured to measure polarization information of the detected light, measure time-of-flight information of the detected light, and measure a distance to the eye based on a combination of the polarization information and the time-of-flight information.

11. The eye tracking system of claim 10, wherein the controller is further configured to measure, based on the polarization information, at least one of position or size of one or more regions of the eye from which the laser light beam is at least one of scattered or reflected.

12. The eye tracking system of claim 10, wherein the detector is configured to detected intensities of the detected light for a plurality of polarizations of the detected light.

13. The eye tracking system of claim 10, wherein the detector includes a first photodetector having a first polarizer exhibiting a first orientation and a second photodetector having a second polarizer exhibiting a second orientation that is different from the first orientation.

14. The eye tracking system of claim 10, wherein the detector includes a first photodetector having a first meta-surface deflecting a first polarization state to the first photodetector and a second photodetector having a second meta-surface deflecting a second polarization state to the second photodetector that is different from the first polarization state.

15. The eye tracking system of claim 10, wherein the detector is configured to detect light from a laser light source having a polarization rotator.

16. The eye tracking system of claim 10, wherein the controller is configured to include the measured distance in eye tracking information.

17. The eye tracking system of claim 10, wherein the time-of-flight information includes a time taken for the laser light beam to at least one of scatter or reflect from the eye and return to the detector.

18. The eye tracking system of claim 10, wherein the controller is configured to combine the polarization information and the time-of-flight information by using the time-of-flight information to resolve data ambiguities in reflected angle data included in the polarization information.

19. A method comprising:
measuring, by a controller, a distance to an object based on a combination of polarization information of detected light and time-of-flight information of the detected light, wherein the detected light results from at least one of scattering or reflection of a light beam from an object;
performing, by an artificial reality system that includes the controller, one or more user interaction procedures based on tracking information that includes the measured distance to the object.

20. The method of claim 19, further comprising:
measuring, by the controller and based on the polarization information, at least one of position or size of one or more regions of the object from which the light beam is at least one of scattered or reflected,
wherein the tracking information further includes the at least one of position or size of the one or more regions.
